(19) United States
(12) Patent Application Publication
(10) Pub. No.: US 2005/0087076 A1
(43) Pub. Date: Apr. 28, 2005

(54) Cooking utensil

(76) Inventor: Marcus Grunewald, Spabrucken (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/501,017

(22) PCT Filed: Dec. 20, 2002
(86) PCT No.: PCT/DE02/04680

(30) Foreign Application Priority Data
Jan. 10, 2002 (DE) 102 00 752.7

(51) Int. Cl. A47J 37/10

(52) U.S. Cl. 99/422

(57) ABSTRACT

A cooking utensil, particularly for fat-free frying or cooking of food to be fried or cooked, comprises a floor and a wall, the floor having an elevated section for placing the food to be fried or cooked and a largely annular depression enclosing the elevated section. The elevated section has at least one groove. The elevated section is convexly curved and/or arched in such a way that frying fat or other liquids may drain into the depression on all sides. The groove allows the temporary return of frying fat or other liquids from the depression to the elevated section so that the wetting of the food to be fried or cooked occurs. Accordingly, a cooking utensil of the type under discussion is designed in such a way that the elevated section is convexly curved and/or arched in such a way that frying fat or other liquids may drain into the depression on all sides, and the groove allows the temporary return of frying fat or other liquids from the depression to the elevated section, so that wetting of the food to be fried or cooked occurs.

### CROSS-REFERENCE TO RELATED APPLICATIONS

This application claims priority of International Application No. PCT/DE02/04680, filed Dec. 20, 2002 and German Application No. 102 00 752.7, filed Jan. 10, 2002, the complete disclosures of which are hereby incorporated by reference.

### BACKGROUND OF THE INVENTION

a) Field of the Invention

The present invention relates to a cooking utensil, particularly for fat-free frying or cooking of food to be fried or cooked, having a floor and a wall, the floor having an elevated section for placing the food to be fried or cooked and a largely annular depression enclosing the elevated section and the elevated section having at least one groove.

The background for a cooking utensil of this type, which is typically provided as a pan having a handle, is low-fat food preparation for a calorie-conscious diet.

b) Description of the Related Art

The teaching of the present patent application is based on related art which results from U.S. Pat. No. 2,198,647 A. The cooking utensil disclosed therein comprises a grid supporting portion having a broiling surface with raised grid means on one face and having a frying surface free from ribs on the opposite face of that portion. The frying surface free from ribs has a concavely curved section so that the frying fat may drain into this section and the food is laying in the frying fat. The broiling surface with raised grid means is comprising an elevated section, parallel ribs, grooves between said ribs extending downward from a transverse median line toward opposite ends of that ribs. The grooves are so deep that they can not allow the temporary return of frying fat or other liquids, so that wetting of the food to be fried or cooked occurs. The parallel ribs prevent that frying fat or other liquids may drain into the depression on all sides.

The pan disclosed in U.S. Pat. No. 3,847,068 has a floor having an elevated, convexly curved section on which the food is cooked or fried. The frying fat or other liquids may flow down into an annular depression. However, there may be cases in which it is necessary for the food to be wetted once again with oil or the cooking juices, whether to prevent sticking or to perform flavoring or moisturizing of the food. In the known pan, the peripheral depression is separated from the elevated section by an edge, so that returning liquid from the depression is very difficult, if possible at all.

A further cooking utensil is known, for example, from U.S. Pat. No. 1,467,272. This is a pan having a peripheral depression and an elevated section. The elevated section defines a planar frying area which is enclosed by an interrupted edge. Frying fat may drain off via the interruptions. This pan has the disadvantage that the frying fat and/or the liquids coming out of the food must first collect on the planar frying area before they may drain off via the interruptions. Therefore, an undesirable dwell time of the food in the fat results.

DE 296 05 888 U1 discloses a pan in which grooves extend over the entire pan floor. Furthermore, a trough is provided into which the grooves largely discharge and into which the fat runs. The depressions of the grooves are described as slanted toward the trough, while the elevations all have the same height and form a planar elevated section in relation to the trough. The cleaning problem because of the frying area structuring is disadvantageous in this pan. In addition, cold bridges to the food to be fried or cooked are formed by the grooves, which may have a disadvantageous effect on its preparation and/or preparation time. The grooves under discussion are also not suitable for returning frying fat because the food is positioned elevated on the elevations and wetting would not occur.

A further cooking utensil is known from DE 299 22 255 U1. This is a cooking utensil having ribs and grooves to avoid the contact between food and frying fat. The food is positioned elevated on the elevations of the ribs and wetting would not occur. According to an embodiment of the cooking utensil under discussion the face having the ribs has the styling of a ridge so that frying fat or other liquids not may drain into the depression on all sides.

### OBJECT AND SUMMARY OF THE INVENTION

On the basis of U.S. Pat. No. 2,198,647, as the related art which forms the species, the teaching of the present patent application is based on the primary object of specifying a cooking utensil of the type under discussion which allows return of frying fat and other liquids to the elevated section with a short dwell time.

The above object is achieved in accordance with the invention in that a cooking utensil, particularly for fat-free frying or cooking of food to be fried or cooked, comprises a floor and a wall, the floor having an elevated section for placing the food to be fried or cooked and a largely annular depression enclosing the elevated section. The elevated section has at least one groove. The elevated section is convexly curved and/or arched in such a way that frying fat or other liquids may drain into the depression on all sides. The groove allows the temporary return of frying fat or other liquids from the depression to the elevated section so that the wetting of the food to be fried or cooked occurs. Accordingly, a cooking utensil of the type under discussion is designed in such a way that the elevated section is convexly curved and/or arched in such a way that frying fat or other liquids may drain into the depression on all sides, and the groove allows the temporary return of frying fat or other liquids from the depression to the elevated section, so that wetting of the food to be fried or cooked occurs.

Firstly, it has been recognized that a return of frying fat and other liquids to the elevated section to wet the food is desirable if necessary, but the returned liquid is to simultaneously have a short dwell time. According to the present invention, at least one groove is provided between the depression and the elevated section, via which the liquid may be returned from the depression to the food and/or to the elevated section, but may then—because of the convex curve—promptly run off again on all sides.

Retaining the convex curve, which is known per se, having a lightly structured surface is advantageous in that a floor structure which is difficult to clean and, in addition, a longer collecting procedure of fat and liquid on the elevated section in the form of a planar frying area may be avoided. Frying fat or other liquids may drain into the depression in all directions. The convex curve is typically an elevated section which is circular in the top view, whose center forms the highest elevation. However, other shapes are also possible here, in consideration of geometrically divided or angular pans in particular, the highest elevation not necessarily having to lie in the center of the elevated section therein.

So that sticking because of a lack of sufficient frying fat may be prevented even better, the convex curve of the elevated section may be especially weakly pronounced. For example, the radius of the convex curve of the elevated section may be approximately 1400 mm to 4000 mm. Through the slight curvature, slow draining is achieved, the adhesion forces between the frying fat and the floor surface being overcome more slowly. In this way, enough frying fat is available for the food. The frying fat may be largely dispensed with when the pores of the food are closed and the danger of sticking is thus reduced and/or largely prevented anyway.

According to an especially preferred embodiment, the convex curve of the elevated section of the cooking utensil may first be implemented during the heating of the heating region and/or the burner. Since there is only a slight need for convexity in order to cause the frying fat to drain off and this fat is also to act initially between the food to be fried and/or cooked, it is an enormous advantage if the frying fat initially remains on the elevated section and then, with increasing heating of the burner and increasing heating of the cooking utensil floor and expansion of the elevated section to form a curve connected therewith, begins to drain into the depression.

In order to offer no obstruction to the drainage of the frying fat and, in addition, to promote cleaning, the elevated section may pass into the depression largely continuously, without forming an edge. The depression is expediently curved concavely, the radius of the concave curve of the depression able to be approximately 13 mm to 15 mm.

If it is considered important that, after running off into the depression, frying fat or the liquid coming out of the food once again arrives between the food and the floor, the elevated section may have at least one groove. The groove discharges into the depression, so that the temporary return of frying fat or other liquids to the elevated section is made possible. So that no excess wetting with frying fat and other liquids has to occur, the groove may diverge in the direction of the depression, and/or converge in the direction of the food to be fried or cooked. Dosing—if desired—may thus be achieved. The groove may advantageously be positioned opposite from the pan handle, so that by lightly pressing down the pan handle, the return of the frying fat which has run off from the depression to the elevated section may be implemented.

For the design of the groove, it would be advantageous if it did not form any undercuts or edges, but rather fits continuously into the edgeless surface of the elevated section. In this case, the radius of the concave curve of the groove, taking the converging and/or diverging path of the groove in the lengthwise direction into consideration, may be approximately 2 to 3 mm in section and the radius of the convex curves of the groove may be approximately 3 mm.

In consideration of returning frying fat under food of larger dimensions to be fried or cooked, multiple, particularly parallel grooves may be provided, the radii of the concave curve of the outer grooves able to be somewhat smaller than those of the inner grooves. The outer regions of the food to be fried or cooked are directly supplied on all sides—not only inside the groove—with frying fat flowing out of the inner region in the direction of the depression again because of the convex curve of the elevated section. The return of frying fat into the outer grooves may thus be kept more sparse. In order to allow the return of the collected frying fat under all of the food to be fried or cooked, the groove(s) may extend over more than half of the elevated section. It is only necessary for the highest elevation of the elevated section, which typically lies in the center, to be overcome in order to then cause drainage and wetting on all sides.

In order to have a reservoir available, from which a larger quantity of frying fat may be returned, the depression may have at least one expansion for collecting frying fat or other liquids. Multiple, for example, two to four, reservoirs and/or expansions may also be provided, which may be positioned radially at predetermined intervals. However, because of the simple lever movement on the pan handle, one single reservoir opposite the handle is preferable. Continuous collection of frying fat in the reservoir and/or in the expansion may be reinforced if the depression has a slope toward the expansion. In addition, the shape of the expansion may be edgeless and have rounded areas which fit into the homogeneous, smooth, and therefore easily cleanable surface of the floor of the cooking utensil according to the present invention. In consideration of the return of the frying fat via the grooves described above, these grooves may discharge into the expansion. In an embodiment without grooves, the goal of the unguided frying fat return may also be achieved through the pivot motion. It is essential in any case that returned frying fat also runs back into the depression immediately because of the convexity of the elevated section. Besides the lowering of cholesterol, a further advantage of the drainage of the frying fat is that spraying up of hot fat may be largely avoided.

From the viewpoint of materials, the floor and the wall of the cooking utensil may be manufactured from aluminum, iron, stainless steel, or copper. In regard to manufacturing, it may be cast aluminum, cast iron, pressed aluminum, or stamped stainless steel. For a cooking utensil made of stainless steel, an antistick coating may be provided.

There are now various possibilities for advantageously implementing and refining the teaching of the present invention. Reference is made to the following explanation of two exemplary embodiments of the present invention on the basis of the drawings. Generally preferred designs and refinements of the teaching will also be explained in connection with the explanation of the exemplary embodiments of the present invention described.

### BRIEF DESCRIPTION OF THE DRAWINGS

In the drawings:

FIG. 1 shows a schematic illustration of a longitudinal section through a first exemplary embodiment of the cooking utensil according to the present invention;

FIG. 2 shows a top view of a second exemplary embodiment of the cooking utensil according to the present invention;

FIG. 3 shows a sectional illustration along the line B-B in FIG. 2; and

FIG. 4 shows a sectional illustration along the line C-C in FIG. 2.

### DESCRIPTION OF THE PREFERRED EMBODIMENTS

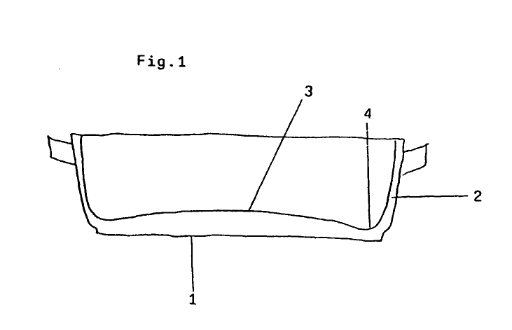

A cooking utensil in the form of a serving pan is shown in FIG. 1 and a cooking utensil in the form of a pan having a handle for fat-free frying or cooking of food to be fried or cooked is shown in FIG. 3, having a floor 1 and a wall 2, the floor 1 having an elevated section 3 for placing the food to be fried or cooked and a largely annular depression 4 which encloses the elevated section 3.

The elevated section 3 is curved and/or arched convexly, so that frying fat or other liquids may drain off into the depression 4.

FIGS. 1, 3, and 4 show that the convex curve of elevated section is very weakly pronounced. The second exemplary embodiment shown in FIG. 3 provides that the radius 5 of the convex curve of the elevated section 3 is approximately 1400 mm to 4000 mm.

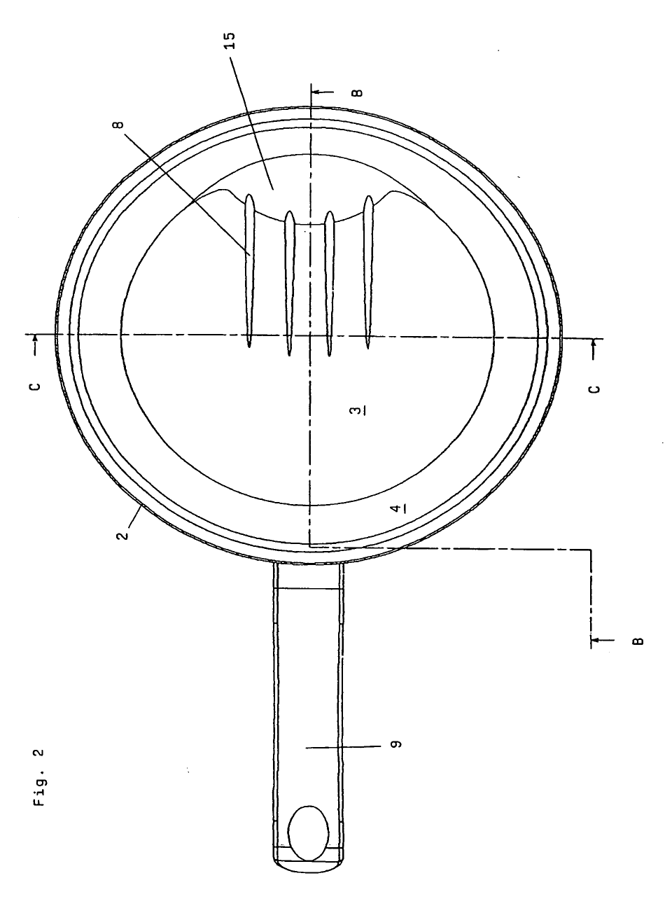

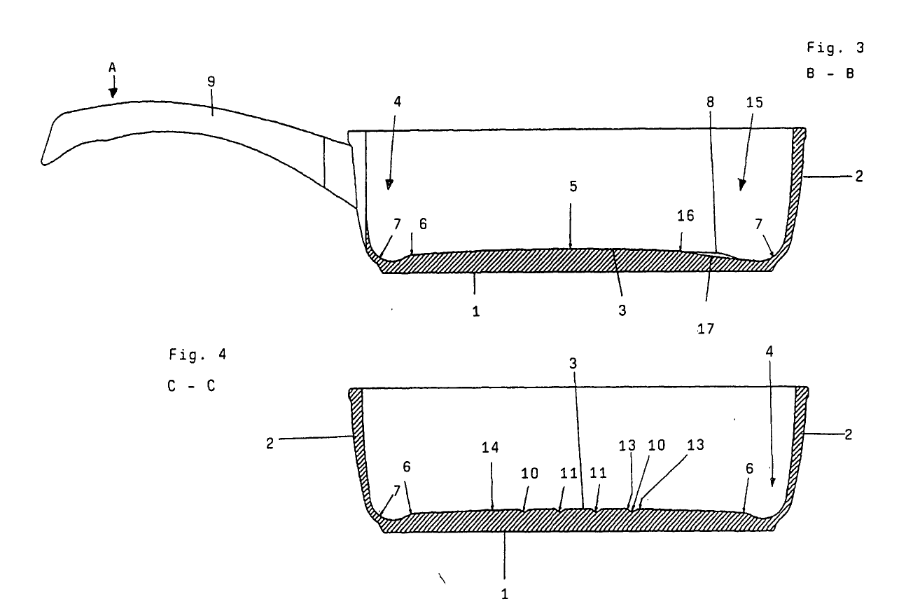

In the two selected exemplary embodiments, the convex curve of the elevated section 3 is shown in the direct—also in the non-heated—state and the elevated section 3 passes largely continuously into the depression 4 without forming an edge. The radius 6 at the transition from the elevated section 3 to the depression 4 is, as shown in the second exemplary embodiment, approximately 15 mm in the sectional illustration along the line C-C of FIG. 2 in FIG. 4 and approximately 5 to 6 mm in the sectional illustration along the line B-B of FIG. 2 in FIG. 3. The depression 4 is curved concavely. The second exemplary embodiment of the cooking utensil according to the present invention provides a radius 7 of approximately 13 mm to 15 mm for the concave curve of the depression 4.

FIGS. 2 and 3 show that the elevated section 3 has four parallel grooves 8, which allow the temporary return of frying fat or other liquids to the elevated section 3. Since the grooves 8 are positioned diametrically opposing the pan handle 9, force may be exerted on the pan handle 9 in the direction of the arrow A to return the frying fat and/or other liquids from the food to be fried or cooked. The grooves 8 discharge into the depression 4, diverge in the direction of depression 4, and extend over more than half of the elevated section 3.

It may be seen from FIG. 4 that the grooves 8 in the elevated section 3 are implemented so that no undercuts result and the elevated section 3 has a largely edgeless surface. The radius 10 of the concave curve of the two outer grooves 8 is 2.61 mm. The radius 11 of the concave curve of the two inner grooves 8 is 2.63 mm. The radius 12 of the convex curve of the grooves 8 is 3 mm. The rounded areas obtained in this way make cleaning easier. The radius 14 of the elevated section 3 is 2000 mm in the region between the outer groove 8 and the depression 4.

The depression 4 has an expansion 15, shown in FIGS. 2 and 3, for collecting frying fat or other liquids, into which the grooves 8 discharge. The expansion is also shaped largely without edges. The elevated section 3 passes into the expansion 15 with a somewhat stronger curve at a radius 16 of approximately 14 to 15 mm, via which a very flat curve having a radius 17 of 400 mm then forms in the direction of the wall 2. The radius 7 of the depression 4 is approximately 1.8 to 2 mm larger in the region of the expansion 15 than the radius 7 in the normal region of the depression 4.

The cooking utensil according to the first exemplary embodiment is manufactured from copper. The cooking utensil according to the second exemplary embodiment is manufactured from stainless steel, an antistick coating being provided.

Reference is made to the general part of the description in regard to further features not shown in the figures.

Finally, it is to be noted that the teaching according to the present invention is not restricted to the exemplary embodiments described above.

While the foregoing description and drawings represent the present invention, it will be obvious to those skilled in the art that various changes may be made therein without departing from the true spirit and scope of the present invention.

1-15. (canceled)

16. A cooking utensil, particularly for fat-free frying or cooking of food to be fried or cooked, comprising:
a floor; and
a wall;
said floor having an elevated section for placing the food to be fried or cooked and a largely annular depression enclosing the elevated section, said elevated section having at least one groove;
said elevated section being convexly curved and/or arched in such a way that frying fat or other liquids may drain into the depression on all sides;
said groove allowing the temporary return of frying fat or other liquids from the depression to the elevated section, so that wetting of the food to be fried or cooked occurs.

17. The cooking utensil according to claim 16, wherein the convex curve of the elevated section is weakly pronounced and the radius of the convex curve of the elevated section is approximately 1400 mm to 4000 mm.

18. The cooking utensil according to claim 16, wherein the elevated section forms the convex curve during the heating of the heating region and/or the burner below the cooking utensil.

19. The cooking utensil according to claim 16, wherein the elevated section passes into the depression largely continuously, without forming an edge.

20. The cooking utensil according to claim 16, wherein the depression is curved concavely and the radius of the concave curve of the depression is approximately 13 mm to 15 mm.

21. The cooking utensil according to claim 16, wherein the groove discharges into the depression and preferably diverges in the direction of the depression.

22. The cooking utensil according to claim 16, wherein the groove in the elevated section is implemented in such a way that no undercuts result and a largely edgeless surface of the elevated section is provided.

23. The cooking utensil according to claim 16, wherein the radius of the concave curve of the groove is approximately 2 to 3 mm and the radius of the convex curves of the groove is approximately 3 mm.

24. The cooking utensil according to claim 16, wherein multiple, particularly parallel grooves are provided and the radii of the concave curve of the outer grooves are somewhat smaller than those of the inner grooves.

25. The cooking utensil according to claim 16, wherein the groove extends over more than half of the elevated section.

26. The cooking utensil according to claim 16, wherein the depression has at least one expansion for collecting frying fat or other liquids.

27. The cooking utensil according to claim 26, wherein the depression has a slope toward the expansion.

28. The cooking utensil according to claim 26, wherein the groove discharges into the expansion.

29. The cooking utensil according to claim 16, wherein the floor and the wall are manufactured from aluminum, iron, stainless steel, or copper.

30. The cooking utensil according to claim 29, wherein cooking utensils made of stainless steel are sealed with an antistick coating.
